(19) United States
(12) Patent Application Publication
(10) Pub. No.: US 2002/0004918 A1
(43) Pub. Date: Jan. 10, 2002

(54) Method for the preparation and execution of a self-test procedure and associated self-test generating method

(75) Inventors: Frederic Mathieu, Villard Bonnot (FR); Frederic Bard, Saint Martin d'Uriage (FR)

Correspondence Address: CHRISTOPHER F. REGAN, ALLEN, DYER, DOPPELT, MILBRATH & GILCHRIST, SUITE 1401, 255 S. ORANGE AVENUE, ORLANDO, FL, 32801, US

(73) Assignee: STMicroelectronics S.A., Montrouge (FR)

(21) Appl. No.: 09/870,121

(22) Filed: May 30, 2001

(30) Foreign Application Priority Data
May 31, 2000 (FR) 0006976

(51) Int. Cl. G06F 11/00

(52) U.S. Cl. 714/30

(57) ABSTRACT

A method is for the preparation and execution of a self-test procedure to validate the behavior of a processor model to be tested. The processor model may be a processor or an associated simulator. The method provides self-test procedures that are immediately executable by all the models of a processor and that give OK/ERROR type results that are easy to interpret.

### FIELD OF THE INVENTION

The present invention relates to the field of electronic circuits, and, more particularly, to a method for the preparation and execution of a self-test procedure and an associated self-test generation method to verify the functions and performance of logic circuits, especially processors.

### BACKGROUND OF THE INVENTION

With the development and increasingly widespread use of integrated electronic systems using programmable processors, there is a large demand for reliable, precise and reusable tools for developing these processors. Such tools may include, for example, optimizer compilers or models (also called simulators) capable of making a bit-by-bit or cycle-by-cycle description of the operation of the processor to allow the exploration and validation of its architecture.

The development and final adjustment of a processor on an integrated circuit requires the creation of simulators. A simulator is a program used to simulate all or part of the behavior of the physical processor. For example, to develop a processor functionality simulators may be used to check the set of instructions of the processor and performance simulators may be used to study the general workings of the physical processor to be made.

Depending upon the complexity (i.e., with respect to functions or performance) of the physical processor to be made, one or more simulators are developed. When the simulators are ready, their latest version is converted into an integrated circuit that corresponds to the physical processor. The simulators are generally developed by different teams and in different programming languages for ease of development. Hereinafter, the expression “processor model” will be used to provide a generic designation of a processor and the simulators created to develop it.

To ensure the reliability of the final processor, it is indispensable, at each step of development, to validate the processor model obtained at each step. That is, it is necessary to ascertain that the processor model (simulator or final integrated circuit) obtained at each step truly has the characteristics and behavior desired.

The validation is done by specific test procedures. For example, during a functionality test procedure, the model is asked to process the execution of a single instruction of a set of instructions to verify its accurate operation. In the same way, during the execution of a performance test procedure, several instructions are executed successively to verify the proper stringing of the instructions. In general, several test procedures are performed in succession and, preferably, automatically. A test procedure is generally implemented in the form of a program (called a test) that can be executed by the processor model to be tested.

After the execution of a test, a result is obtained. This result corresponds, for example, to the contents of the elements of the processor model after the execution of the test. The result may also correspond to the changes undergone by the contents of the elements of the model at each clock cycle and throughout the period of execution of the test. As used herein, “elements of the processor model” are elements such as the memories of the registers of the model to be tested, for example. The result of the test is generally stored in a result file, called the trace of the test procedure. The contents of the result file (type of information, order, etc.) are defined in the test procedure.

Given the complexity of present-day processor models and, therefore, the number of tests to be performed to validate them accurately and reliably, it is no longer possible to write the test procedures or the tests by hand. Test generation methods are used, giving test procedures or tests depending on the parameters dictated by the user. The parameters may include, for example, the name and the functional definition of an instruction of the set of instructions of the processor model to be tested or the order in which the successive instructions have to be executed. Test generation methods of this kind are implemented by test generators, i.e., programs carrying out the different steps of the associated methods.

A test generator is generally developed by a particular processor model and gives test procedures in a language that can be understood first by the model to be tested and second by the control interface of the model and the tools used to develop it. Currently, to develop a processor, at least one test generator is developed for each type of processor model, e.g., one for the performance simulator, one for the final processor, etc. Although the tests to be made are often identical in principle, two test generators will give different test procedures which are adapted to the processor models for which they are intended. Additionally, throughout the period of development of the processor the test procedures given by the different test generators are stored. This requires large data storage capacity.

Furthermore, the trace (i.e., the result) given by a test procedure depends upon the way in which the procedure has been obtained. In particular, two test procedures obtained from two different test generators may give different traces, especially with respect to the type of information and format. For example, to test the embodiment of an addition operation C=A+B, a first test procedure gives a trace indicating the contents of the register C at the end of the execution of the test. A second procedure gives a trace indicating the development of the contents of the register C throughout the performance of the same test. In such cases, it is not possible to directly compare the two traces, and it is necessary to use a translator or an interpreter.

Further, the trace of a test procedure cannot be directly exploited by current test generators. This is because such test generators do not know the expected result of the test procedure they have generated and they are unable to obtain this result. Therefore, it is necessary to sort out and validate all the test procedures given by a generator to keep only the accurate tests, or only those tests whose result is valuable for the user. Indeed, tests given by a test generator may be redundant, while others provide very little information or have programming errors which appear therein.

To validate and use the test given by current test generators, it is necessary to know the expected result of the test procedures that they execute. For this purpose, it is the general practice to use a perfect reference processor model that gives the expected result for each test or test procedure. To find out whether the processor model to be tested is accurate or not, it is then necessary to compare the trace given by a test procedure executed by the model with the trace given by the same test procedure when it is performed by a reference model.

Yet, difficulties may arise in such comparison, and it may be necessary to use an interpreter or translator to make this comparison. Furthermore, the precision of current test generators depends upon the precision of the available reference simulators. Also, it is difficult to obtain perfect reference models, which of course must themselves be valid. It is even more difficult to obtain a reference model that can use all the instructions and all the functions of a processor model to be tested.

### SUMMARY OF THE INVENTION

An object of the invention is to provide a method that can be used to quickly obtain test procedures and tests that can be used for the different types of models (simulators or final processors) needed for the development of a processor, with neither matching nor modification.

It is another object of the invention to implement a method by which a user can obtain test procedures and tests that give results in a simple form that can be directly used with all the development tools of the processor.

These and other objects, features, and advantages in accordance with the present invention are provided by a method for the preparation and execution of a self-test procedure to validate the behavior of a processor model to be tested. The processor model may be a processor or an associated simulator. The method may include receiving specifications (E2) from a user concerning at least one instruction to be tested of a set of instructions of the processor model and reading (E4), in a table, characteristic data of the processor model to be tested. The data may include a functional definition of the instruction to be tested and a functional definition of the elements of the processor model.

Furthermore, the method may also include computing an expected result (E6) at the end of the execution of the instruction to be tested. The computation may be made from specifications of the user and characteristic data of the processor model. Additionally, the model to be tested may be made to carry out a self-test procedure (E8) to validate the instruction to be tested. The self-test procedure gives, in return, a result word that is equal to a first value if the behavior of the processor model is right and a second value if the behavior of the processor model is not right.

Thus, according to the invention, the result can be directly used by the user without requiring the comparison step or additional translation step, for example. Furthermore, the method of the invention may be used directly with all of the processor models. This then limits the number of tests needed for the full development of a processor, namely the time needed to validate all the processor models used for its development, including the final processor. The time needed for the validation of all the models as well as the requirements of storage of the different tests are therefore reduced.

A result equal to the first value generally indicates first that the self-test procedure E8 is accurately implemented. Secondly, it may also indicate that the processor model being tested reacts accurately with respect to the instruction or instructions to be executed. Conversely, a result equal to the second value means either that the processor model is not accurate with respect to the expected specifications or that the self-test procedure is not accurately implemented (because of an injudicious choice of the instructions to be tested, a write error for the implementation of the procedure, incorrect parameters, etc.).

Preferably, the self-test procedure (E8) may include initializing (E81) the elements of the processor model to be tested, executing the instruction to be tested (E82) and obtaining a result, comparing the obtained result and the expected result (E83), and giving (E84) a word that is the result of the comparison. According to one embodiment, only one instruction of the set of instructions of the processor model is executed, thus enabling the testing of the functional behavior of the model. According to another embodiment, at least two instructions of the set of instructions of the processor model are executed successively. This is done to validate the performance characteristics of the processor model to be tested.

Thus, a self-test procedure is a test procedure including an initialization of the elements (registers and/or memories) of the processor model to be tested, one or more instructions to be executed, a computation of an expected result and a comparison of the expected result with the result obtained after execution of the instruction or instructions to be executed. The test procedure may provide an easily interpretable result of the true/false type. A self-test procedure is therefore a test procedure that is independent because it is executed without any instruction other than a start instruction, and it need not be validated before it is used. According to the invention, therefore, there is no longer any need to have a reference model to validate the self-test procedures.

The procedure may also include making the model to be tested carry out a self-test procedure (E8) and receiving a result word. Next, a decision is made (E10) such that if the above result is equal to the first value then a step E12 is performed. Otherwise, if the above result is equal to the second value, a step E14 is performed. The step E12 may include, if another self-test procedure has to be executed, carrying out a new step E8, and otherwise ending the method. Also, the step E14 may include storing information on the self-test procedure previously performed. The information may include an address at which an error has been detected (if an error has been detected). The method may then be completed.

The above described steps E8 to E14 are preferably preceded by initialization steps including receiving specifications from a user (E′2) concerning at least two self-test procedures and reading (E′4), in a table, characteristic data of the processor model to be tested that is needed for the execution of the self-test procedures. Further, the above step E6 may be executed (E′6) successively, where each execution corresponds to a self-test procedure. This has the advantage of executing several successive self-test procedures, limiting the user's action (if he so desires) to the case where the self-test procedure gives an incorrect result.

Next, after the step E′6, a step E7 is carried out to give the user a statistical study of the instructions to be tested during the following step E8. The user thus knows precisely which instruction will be tested and how many times each instruction or combination of instructions will be executed. In other words, for all the self-test procedures that will be executed, the user has precise knowledge of the coverage of the set of instructions and performance characteristics of the processor model to be validated. In the same way, a step E16 may also be performed at the end of the method which gives a statistical study of the results furnished during all the self-test procedures executed by the model being tested.

Another method aspect of the invention is for generating self-test programs and includes, in addition to the steps E2 to E6 of the method described above, writing (E′8) a self-test program to obtain the execution of a self-test procedure by the processor model. This program, when stored, can subsequently be used by the processor model that is to be tested. For this purpose, the self-test program is preferably written in an assembler type language that can be understood by all the models to be tested of the processor. Further, the initializing steps may be performed based upon instructions of the set of the instructions of the model to be tested, all the models the processor having the same set of instructions.

One self-test procedure according to the invention can thus be used by all the models of the processor. The number of self-test procedures to be developed is therefore limited in reality, since it is not necessary to develop specific procedures for each model. The time used to carry out the self-test procedures is therefore limited, as are the requirements of storage of these procedures.

Furthermore, since the same self-test procedure can be performed by different processor models, the user no longer needs to use an interpreter or a translator to compare two results of the same self-test performed on two different processor models, for example. Again, the self-test generation method of the invention is preferably implemented in the form of a program written in an advanced DGL and/or C++ type language that can be understood by the user, thus facilitating the work of development and implementation of this method. The user then, by way of relatively simple modifications, can easily obtain self-test procedures and self-tests for any type of processor model, e.g., for the development of new processors.

### BRIEF DESCRIPTION OF THE DRAWINGS

The invention will be understood more clearly and other characteristics and advantages will appear from the following description, made with reference to the appended drawings, in which:

FIG. 1 is a flow diagram of an algorithm for implementing a method of preparation and execution of a self-test procedure according to the invention;

FIG. 2 is a flow diagram illustrating in more detail one of the steps of the algorithm of FIG. 1; and

FIG. 3 is a flow diagram of the algorithm of FIG. 1 illustrating additional embodiments thereof.

### DETAILED DESCRIPTION OF THE PREFERRED EMBODIMENTS

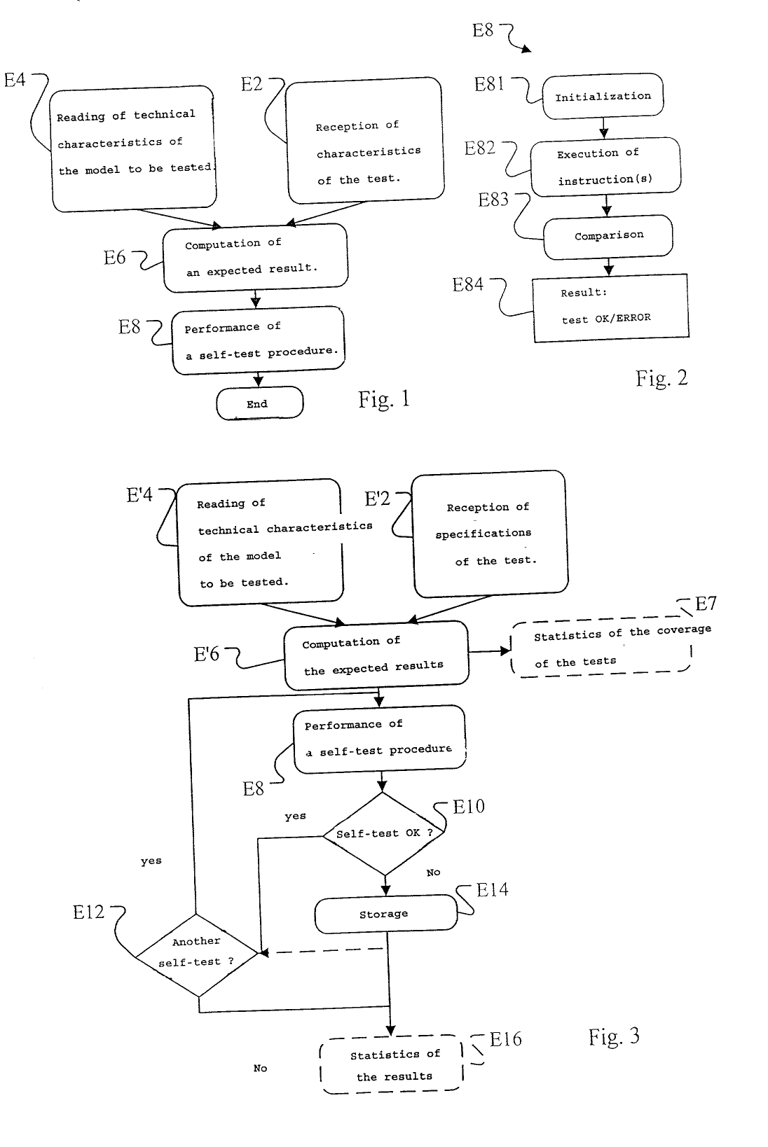

The method according to the invention illustrated in FIG. 1 is used to prepare and execute a self-test procedure to test the behavior (i.e., with respect to functionality or performance) of a processor to be validated or an associated simulator, where the simulator is a model used to simulate the behavior of the processor. The method is, for example, implemented by a control interface of the central processing unit or workstation driving the functioning and operations of tests on the model to be tested. This is done in the form of a program to be tested (simulator) or a circuit (physical processor) to be tested.

As above, the expression “processor model” will be used in the following discussion to designate a corresponding processor or simulator. The method illustrated in FIG. 1 includes a step E2 for the reception of specifications, a data reading step E4, a step E6 for computing an expected result, and a step E8 for carrying out a self-test procedure. This latter step is executed by the model being tested.

During the step E2, the user specifies the type of test that he wishes to perform, especially the instructions that have to be executed by the processor model to be tested. The instruction or instructions to be tested are, of course, instructions from the set of instructions of the model being tested. These instructions are in principle the only ones that can be executed. The user, for example, chooses a single instruction if he wishes to carry out a test on the functionality of the set of instructions of the model to be tested, namely if he wishes to ascertain that the selected instruction has been accurately executed by the model to be tested. The user can also choose two or more instructions if he wishes to carry out a test on the performance of the processor model by specifying the order in which the chosen instructions have to be executed.

The user also specifies the initial values to be taken into account to execute the instructions chosen earlier during the step E2. For example, if the user wishes to obtain the execution of an addition operation C=A+B, then he will specify the numerical values of A and B and the registers in which they have to be stored and the name of the instruction ADD to be used. Furthermore, he will also specific at least one address to indicate the place in which the result must be stored (if it is stored) and, as the case may be, an address at which a capacity overflow (if any) must be stored.

During the step E2, the user finally defines the information that he wishes to obtain in return after the execution of the instruction or instructions. In the event of an addition operation, the user may specify, for example, that he wishes to obtain the contents of the result registers and find out if any capacity overflow has taken place. He may also choose to ask for information on the progress of the contents of all the registers of the model to be tested, cycle by cycle, during the execution of the chosen instruction.

During the step E4, parameters corresponding to technical characteristics of the model of the processor to be tested are read in a table of characteristics. The parameters read include especially a functional and behavioral description of the instruction or instructions to be executed, and also a functional description of the elements of the processor model to be used to execute the instruction or instructions. This description may include their address, their size, etc. The parameters read depend, of course, upon the specifications of the users specified in the step E2.

The table of characteristics includes all the technical characteristics of the processor model being tested. In particular, the table includes a precise functional and behavioral description of all the elements of the model. The elements of the processor model may be physical elements or functional elements. The physical elements are, for example, the registers, the memories, the calculation units of the model, etc. The functional and behavioral description of each physical element is done by way of mathematical and/or logical equations. These equations indicate how the physical element reacts when it is requested. Also, these equations indicate how the physical element acts on the other elements of the model when it is requested.

The functional elements are essentially instructions from the instruction set of the model to be tested. The functional and behavioral description of each functional element is also done by way of mathematical and/or logical equations. These equations indicate this time which elements will act during the execution of the functional element (or instruction), in which order, etc. These equations also indicate the compilation rules associated with each instruction. All the information elements included in the table can be given by the user during a step E0 (not shown in FIG. 1) for the initialization of the method, for example. These information elements can also be obtained and stored in a memory.

During the step E6, a theoretical result is computed corresponding to the result to be expected if the test is performed properly and if the model to be tested is accurate. The theoretical result computed depends first upon the specifications of the user specified during the step E2. Second, the result depends upon the technical characteristics of the model being tested, these characteristics being read during the step E4. The expected result is thus computed directly from the characteristics of the processor. As seen above, the technical characteristics of the model are defined with mathematical and/or logical equations. Thus, the expected result can be easily calculated. It is therefore not necessary to have a reference processor model available to obtain these expected results, which is particularly advantageous.

The expected result may have different formats, depending upon the users preference. For example, the expected result may be a list of the value that should be present in each register and/or each memory of the model after execution of one or several instructions. The expected result may also be a list of values showing the evolution of a register or memory contents during the execution of one or several instructions.

In the case of the addition operation C=A+B described above, the computed theoretical result includes the number C in binary form which must be included in the result registers if the test is right as well as the contents of a register indicating whether a capacity overflow has to take place. The steps E2, E4 and E6 above prepare for the performance of the next self-test procedure E8 which is executed by the model to be tested according to the instructions of the control interface that implements the method of the invention.

The self-test procedure E8 includes, as illustrated in FIG. 2, an initialization step E81, an instruction execution step E82, a comparison step E83 and a result furnishing step E84. During the initialization step E81, all the elements (registers, memories, computation circuits, etc.) of the processor model being tested are initialized. For example, the initial values, if they exist, are loaded into the corresponding registers. The registers that do not receive any initial value receive a zero, the computation circuits are initialized, etc.

During the instruction execution step E82, the instruction or instructions to be tested are executed according to the specifications of the user specified in the step E2, and a result is extracted from the model being tested. The extracted information elements are specified by the user during the step E2. For example, in the case of the operation C=A+B, the result obtained includes the number C, contained in one or more result registers, and a piece of information indicating whether or not a capacity overflow has taken place during the performance of the step E82.

During the performance of the next step E83, a comparison is made between the result computed during the step E6 and the result actually obtained during the step E82. One result of the comparison is finally given (step E84) and stored, as the case may be. The result of the comparison takes two values which, for example, are the value OK if the comparison indicates that the results expected and obtained are the same, and the value ERROR if not.

A result equal to OK generally indicates first that the self-test procedure E8 has been properly implemented and, secondly, that the processor model being tested reacts accurately in relation to the instruction or instructions to be executed. Conversely, a result equal to ERROR indicates either that the processor model is not accurate with respect to the expected specifications or that the self-test procedure is not being correctly implemented (due to an injudicious choice of instructions to be tested, a write error for the implementation of the procedure, incorrect parameters, etc.).

A relatively simple embodiment of a method of preparation and execution of a self-test procedure according to the invention is illustrated in FIG. 1. In a preferred embodiment, the self-test procedure E8 is implemented in the form of a self-test program (more simply called a self-test). The example illustrated in FIG. 1 can be modified in different ways without departing from the framework of the invention. Some possible modifications are shown in FIG. 3.

A first modification is used to carry out several self-test procedures E8 in succession automatically, providing a considerable gain in time. As above, during the step E′2 the user specifies the set of instructions to be tested, the order in which they have to be tested, the initial values to be taken into account and the results to be extracted for each self-test procedure to be performed. During the step E′4, the parameters needed to carry out all the self-test procedures are read in the table. In the step E′6, the results expected for each self-test procedure are computed successively.

The steps E′2, E′4 and E′6 described above prepare the performance of the following steps E8, E10, E12 and E14. A first step E8, identical to the one described with respect to FIG. 1, is then carried out. A first decision step E10 is then carried out. If the result of the above step E84 indicates no error (OK), then a second decision step E12 is performed to find out whether a new self-test procedure E8 has to be performed or not. If the result of the step E12 is positive, then a new step E8 is performed. If not, the method ends.

If the result of the above step E84 shows an error (ERROR), then a storage step E14 is performed during which information on the incorrect self-test procedure is stored. The information includes, in particular, the address at which the error has been detected. This information is obtained from the architectural state of the processor being tested. The method then terminates at the end of the storage test E14. Thus, the test ends as soon as a self-test procedure gives an error result. The user then immediately knows which self-test procedure has raised a problem and which functionality and/or performance of the model being tested is not in accordance with his wishes.

In a preferred embodiment, all the steps E8, E10, E12 and E14 are implemented in the form of a self-test program, more simply called a self-test. Moreover, the decision step E12 may be carried out after the storage step E14 (i.e., the addition of the link shown in dashes between the step E14 and E12 in FIG. 3 and the elimination of the link between the steps E14 and E16). In this case, all the self-test procedures E8 of the method are performed, whatever the result (OK/ERROR) of one of these procedures E8. Furthermore, whenever a procedure E8 gives an error result ERROR, then the information on this procedure is stored (step E14). The procedure ends when all the self-test procedures E8 have been performed.

All the information stored during the performance of the step E14 enables the user to subsequently see which self-test procedure raises problems. The method illustrated in FIG. 3 may also be modified by the addition of statistics-providing steps E7 and/or E16 (shown in dashes in FIG. 3). These steps are especially useful when several self-test procedures are performed successively.

During the step E7, after the step E′6 for computing expected results, a statistical study is made of all the instructions that will be used during the performance of the next self-test steps E8. This result especially enables the user to know the coverage of the instructions tested, i.e. to respond especially to questions of the following type: how many times has one and the same instruction been used?; are the instructions of the set of instructions of the processor being used or not?; are all the combinations of two (or more) instructions being used?; etc.

Similarly, the step E16 gives a statistical study of the results of the self-test procedure performed earlier. It also gives the user an answer to questions of the following type: how many of the self-test procedures give an error result?; what instructions are used by the procedures that give an error result?; etc. Statistical tests of this kind are not indispensable for implementing the invention but help the user in his choices of self-test procedures to be performed. They also enable him to ascertain that the processor model being tested responds or does not respond to the expected specifications.

As stated above, a self-test method such as the step E8 of the method illustrated in FIG. 1 is implemented in the form of a self-test program or self-test. For this purpose, another method aspect of the invention is for a self-test generation method including the steps E2, E4, E6 as described with reference to FIG. 1 and also including a step E′8 for writing a self-test program to execute a self-test procedure including the sub-steps E81 to E84 described above. Naturally, if a self-test program has to be carried out for the method illustrated in FIG. 3, it will also account for the steps E8, E10, E12 and E14 to be performed.

Preferably, the self-test generation method gives the self-test described in an assembler type language. This has the advantage of being executable by all the processor models to be tested and simulators used for development or final processors, for example. For the same processor, two processor models have the same technical characteristics. Thus, with the invention, it is then no longer necessary to write different self-tests for different models. This enables a significant reduction in the time needed to carry out these self-tests, as well as the storage capacities needed to store them. Furthermore, if a new processor has to be developed, it is enough to modify the parameters of the table of characteristics used during the step E4 and then once again carry out the self-test generation method to obtain self-tests simply and speedily for the new processor and its associated models.

That which is claimed is:

1. A method for the preparation and execution of a self-test procedure to validate the behavior of a processor model to be tested, the processor model being a processor or an associated simulator, wherein the method comprises the following steps, consisting in:
receiving specifications (E2) from a user concerning at least one instruction to be tested of a set of instructions of the processor model,
reading (E4), in a table, characteristic data of the processor model to be tested, the data comprising especially a functional definition of the instruction to be tested and a functional definition of the elements of the processor model,
computing an expected result (E6) at the end of the execution of the instruction to be tested, the computation being made from specifications of the user and characteristic data of the processor model, and
making the model to be tested carry out a self-test procedure (E8) to validate the instruction to be tested, the self-test procedure giving, in return, a result word that is equal to a first value (OK) if the behavior of the processor model is right, and equal to a second value (ERROR) if the behavior of the processor model is not right.

2. A method according to claim 1, wherein the self-test procedure (E8) comprises the following sub-steps, consisting in:
initializing (E81) the elements of the processor model to be tested,
executing the instruction to be tested (E82) and obtaining a result,
comparing the obtained result (E83) and the expected result, and
giving (E84) a word that is the result of the comparison (OK/ERROR).

3. A method according to one of the claims 1 to 2, wherein at least two instructions of the set of instructions of the processor model are executed successively, to validate the performance characteristics of the processor model to be tested.

4. A method according to claim 1, comprising the following steps, consisting in:
making the model to be tested carry out a self-test procedure (E8) and receiving a result word,
taking a decision (E10): if the above result is equal to the first value, then performing a step E12, else, if the above result is equal to the second value (ERROR), carrying out a step E14,
taking a decision (E12): if another self-test procedure has to be executed, then carrying out a new step E8, if not, end of method, and
storing (E14) information on the self-test procedure performed previously, the information containing especially an address at which an error has been detected, and then end of method.

5. A method according to claim 4, furthermore comprising the following initialization steps, to be executed before the first step E8:
receiving specifications from a user (E′2) concerning at least two self-test procedures,
reading (E′4), in a table, characteristic data of the processor model to be tested, necessary for the execution of the self-test procedures,
executing (E′6) several steps E6 successively, each step E6 corresponding to a self-test procedure.

6. A method according to one of the claims 4 or 5, furthermore comprising the following step E7, executed after the step E′6 and consisting in:
giving a statistical study (E7) of the instructions to be tested during the following steps E8, to estimate the coverage of the set of instructions and performance characteristics of the processor model to be validated.

7. A method according to any of the claims 4 to 6, furthermore comprising the following step E16, performed at the end of the method and consisting in:
giving a statistical study (E16) of the results (OK/ERROR) furnished during all the self-test procedures (E8) executed by the model being tested.

8. A method for the generation of self-test programs, comprising the steps E2 to E6 of the method according to one of the claims 1 to 7, and furthermore comprising the following step E′8:
writing (E′8) a self-test program to obtain the execution of a self-test procedure (E8) by the processor model.

9. A method according to claim 8 wherein, during the step E′8, the self-test program is written in an assembler type language, that can be understood and executed by all the models to be tested of one and the same processor.

10. A method according to one of the claims 8 or 9, wherein the step E81 is performed on the basis of instructions of the set of the instructions of the model to be tested.

11. A method according to one of the claims 8 to 10, implemented in the form of a program written in an advanced DGL and/or C++ type language that can be understood by the user.
